(19) United States
(12) Patent Application Publication
(10) Pub. No.: US 2006/0224821 A1
(43) Pub. Date: Oct. 5, 2006

(54) System for parallel updating flash memory and method for the same

(75) Inventors: Ying-Chu Chen, Hsinchuang City (TW); Jih-Liang Juang, Tou Cheng Jen (TW)

Correspondence Address: BIRCH STEWART KOLASCH & BIRCH, PO BOX 747, FALLS CHURCH, VA, 22040-0747, US

(73) Assignee: MEDIATEK INCORPORATION

(21) Appl. No.: 11/392,703

(22) Filed: Mar. 30, 2006

(30) Foreign Application Priority Data
Apr. 1, 2005 (TW) 94110437

(51) Int. Cl. G06F 12/00

(52) U.S. Cl. 711/103

(57) ABSTRACT

A parallel memory updating method and its system are proposed in the present invention. The present invention is applied for a host computer and makes the host computer capable of using pipeline concept to update multiple peripheral devices at the same time. Thus, the updating efficiency is greatly improved. The parallel flash memory updating method includes the following steps: sending a START_FLASH_CMD command via an IDE interface to make the peripheral devices switch to a flash memory updating mode; send out a WRITE_ENABLE command to enable a writing function of the flash memories of the peripheral devices; and writing firmware data to the flash memories of the peripheral devices.

### BACKGROUND OF THE INVENTION

1. Field of the Invention

The present invention is related to a system and method for parallel updating non-volatile memory, and more particularly, to a system and a method that take advantage of the interface between host PC and the device such as PATA, SATA and USB and a pipeline concept to update multiple peripheral non-volatile flash memories at the same time.

2. Description of Related Art

Reference is made to FIG. 1, which shows a conventional system for updating a peripheral flash memory. This system has a host computer 101, a peripheral device 102 and a signal transmission line 103. The host computer 101 uses an integrated device electronics (IDE) interface (not shown) and the signal transmission line 103 to connect with the peripheral device 102, which has a flash memory (not shown) used to store firmware data and control codes.

Reference is made to FIG. 2, which shows a block diagram of a system for updating a peripheral flash memory as disclosed in U.S. Pat. No. 6,507,881. As shown in FIG. 2, the system includes a circuit having a microprocessor 200, a flash read-only memory 202, a flash memory controller 204 and a random access memory (RAM) 206. The flash memory controller 204 is connected to a host computer 28 via an IDE interface for transmitting a firmware updating command and the data related thereto. By redefining the task file of the IDE interface, the host computer 208 can directly update the non-volatile memory 202. When the host computer 208 is ready to update the non-volatile memory 202, it first sends a START_FLASH_CMD command to the flash memory controller 204 to make the flash memory controller 204 switch to a flash memory updating mode. After that, the host computer 208 can use the redefined task file to drive the flash memory controller 204 to update the flash read-only memory 202.

After the flash memory controller 204 is switched to the flash memory updating mode, the host computer 208 prepares to transfer the new firmware data to the flash memory controller 204 via the redefined task file. After the host computer 208 makes sure that the flash memory controller 204 is ready to receive the new firmware data, the host computer 208 starts to transfer the new firmware data to the flash memory controller 204. After receiving the new firmware data, the flash memory controller 204 stores the new firmware data into the random access memory (RAM) 206 temporarily.

After the flash memory controller 204 has received a predetermined amount of the new firmware data, it notifies the host computer 208 that it will stop transferring the new firmware data via its internal registers. Then, the flash memory controller 204 writes the new firmware data received into the flash read-only memory 202. When the new firmware data received is completely written into the flash read-only memory 202, the flash memory controller 204 resets its internal registers to notify the host computer 208 to transmit the remaining firmware data. The flash memory controller 204 repeats the steps mentioned above until the firmware codes and data of the flash read-only memory 202 are updated completely.

In the past, the capacity of the flash memory was quite small. Hence, the amount of necessary firmware codes and data were also small. As such, using the method mentioned above to update the flash memories of the peripheral devices one by one didn't consume too much time. However, nowadays the capacity of the flash memory and the amount of the necessary firmware codes and data needed for the peripheral device have been increased greatly. Thus, updating the flash memory of the present peripheral device consumes much more time. Hence, using the methods mentioned above to update the flash memories of the peripheral devices one by one could consume a tremendous amount of time. For companies producing peripheral devices with flash memories on a mass scale, the method mentioned above is very inefficient and greatly reduces the production quantity.

### SUMMARY OF THE INVENTION

An objective of the present invention is to provide a method and system for parallel updating the non-volatile memories of peripheral devices. The method of present invention can be applied for a host computer and make the host computer capable of using a pipeline concept to update the non-volatile memory of multiple peripheral devices at the same time. Thus, the updating efficiency is greatly improved.
1. Separate one non-volatile memory updating flow into several sub-flows, such as START FLASH, WRITE ENABLE, ERASE and PAGE WRITE etc.
2. Using the interface between the host PC and the peripheral devices as the updating path of the non-volatile memory of the peripheral devices.
3. Updating the non-volatile memories of the peripheral devices at the same time by using the pipeline concept. The predefined sub-flows are used as the atomic steps of the non-volatile memory-updating pipeline.

By using the pipeline concepts, the time of the necessary steps of the peripheral devices can overlap to each other. The non-volatile memory updating efficiency of multi-devices is greatly improved.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a conventional system for updating a peripheral flash memory;

FIG. 2 shows a block diagram of a conventional system for updating a peripheral flash memory;

FIG. 3 shows a system used to update multiple flash memories of peripheral devices in accordance with the present invention;

FIG. 4 is a block diagram of a peripheral device in accordance with the present invention;

FIG. 5 shows an operative flowchart of the parallel memory updating program in accordance with the present invention;

FIG. 6 shows the detailed operation of the flash memory updating method in accordance with the present invention; and

FIG. 7 shows a time diagram of the operative steps of the method for updating flash memories of peripheral devices according to the present invention.

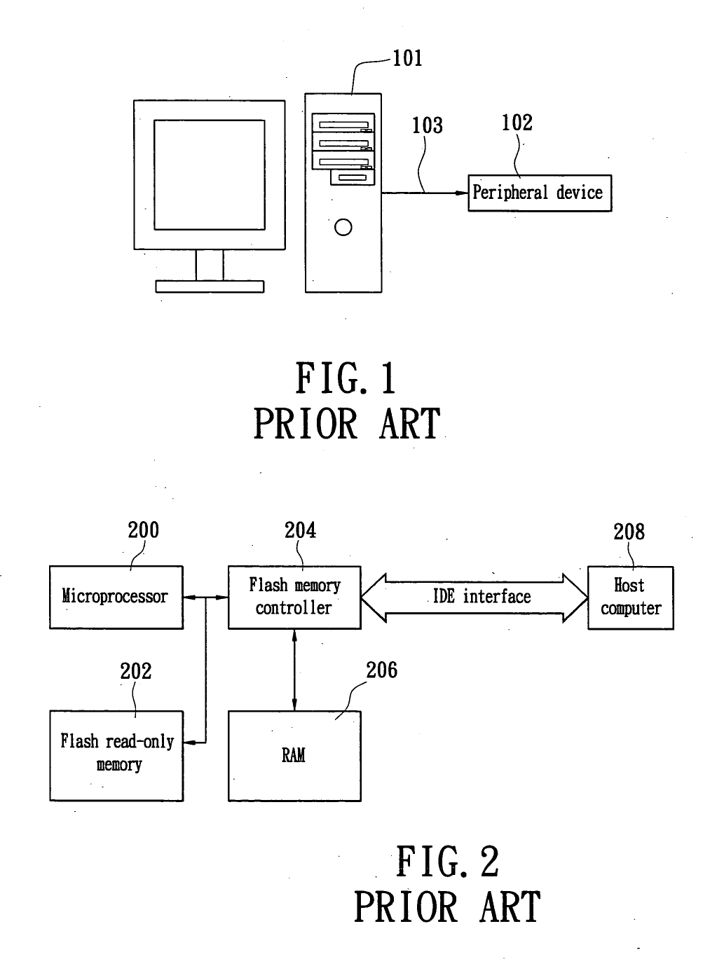

### DETAILED DESCRIPTION OF PREFERRED EMBODIMENTS

Reference is made to FIG. 3, which shows a system used to update multiple flash memories of peripheral devices in accordance with the present invention. As shown in FIG. 3, the system of the present invention has a host computer 301, multiple peripheral devices 302 and multiple signal transmission lines 303. The host computer 301 uses an SATA interface. Please note that the SATA is one of the interfaces that can be applied to this method. The signal transmission lines 303 to connect the peripheral devices 302. Each of the peripheral devices 302 has a non-volatile memory (not shown) to store some consistent data such as firmware. Therein, the peripheral devices 302 can use the consistent data stored in the non-volatile memories.

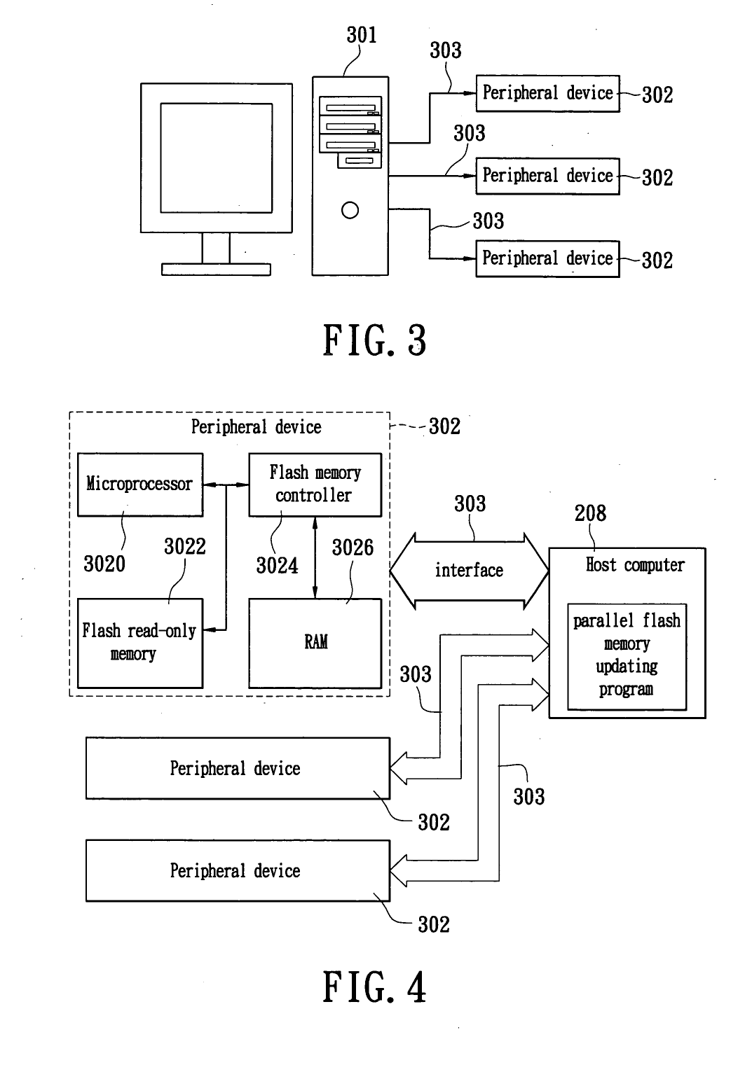

Reference is made to FIG. 4, which is a block diagram of a peripheral device in accordance with the present invention. As shown in FIG. 4, each of the peripheral devices 302 has a microprocessor 3020, a non-volatile memory 3022, a memory controller 3024 and a random access memory (RAM) 3026. The host computer 301 has a parallel memory updating program 3011 for non-volatile memory installed thereon. The flash memory controller 3024 is connected to the host computer 301 via the interface for transmitting a firmware updating command and the data related thereto. The parallel memory updating program for non-volatile memory 3011 is used to control the flash memory controllers 3024 of the peripheral devices 302 to update the flash read-only memories 3022 in a parallel way at the same time.

The present invention will take a serial flash updating scenario for example to describe current invention. First of all, we will introduce the base flow of the paralleling updating flow of one peripheral device. Particularly, the parallel memory updating method is applied for a host computer, and the host computer is capable of updating the aforementioned non-volatile memories of multiple peripheral devices via the interface at the same time. The preferred embodiment of the claimed method has a step of separating one non-volatile memory updating flow into one or more sub-flows for different peripheral devices of the host computer, and a step of executing the sub-flows individually afterward.

From above-mentioned steps, each sub-flow has a specific period of execution time, and the sub-flows comprise the commands such as START FLASH, WRITE ENABLE, ERASE and PAGE WRITE etc. More, the interface, which is intervened the host computer and the peripheral devices, is regarded as the updating path of the non-volatile memory of the peripheral devices. Next, the pipeline concept is used to process the step of updating the non-volatile memories of the peripheral devices at the same time, and the predefined sub-flows are used as the atomic steps of the non-volatile memory-updating pipeline.

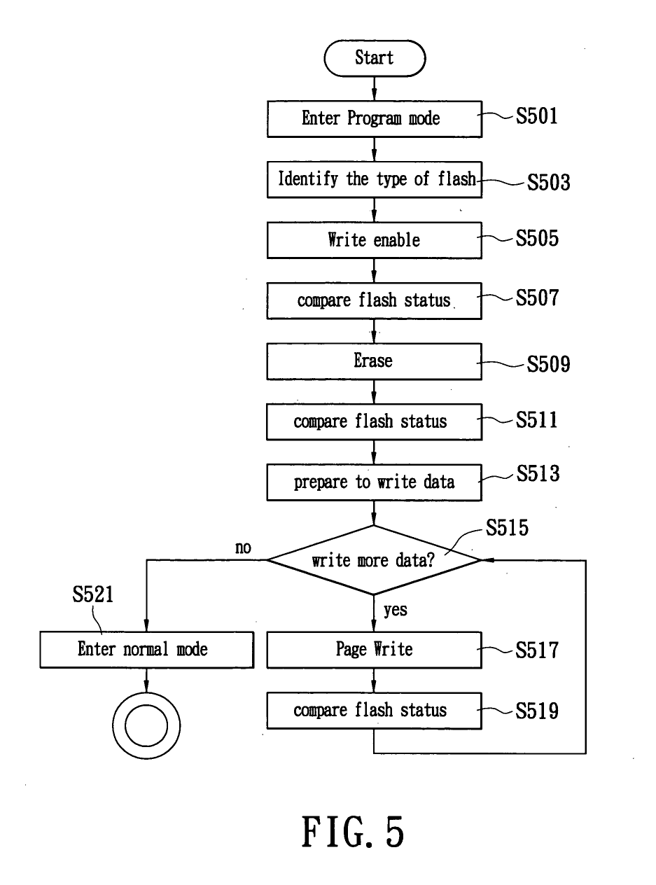

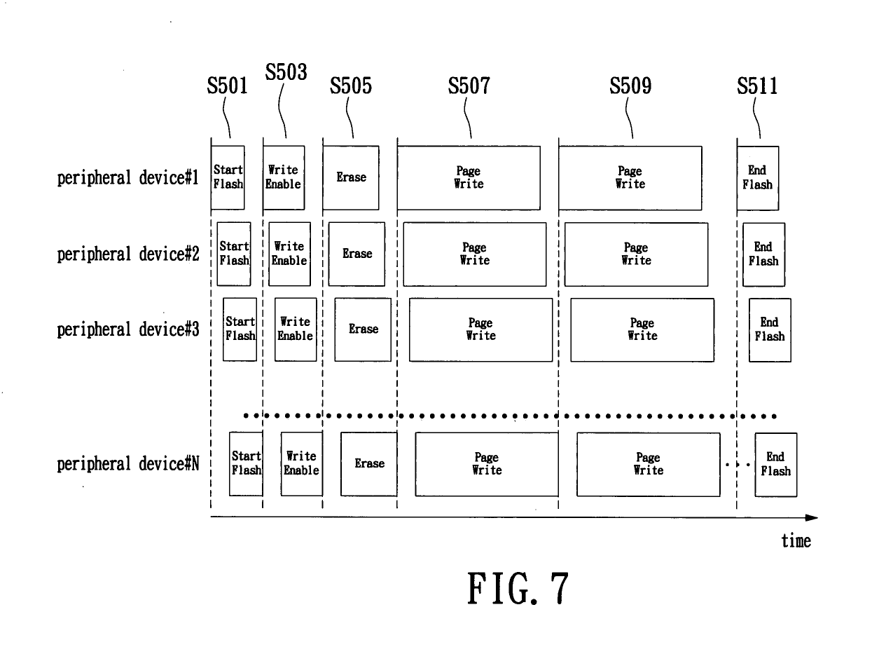

Please refer to the preferred embodiment of the present invention show in FIG. 5 as follows:
1. The first step (step S501) of the flow is to enter a PROGRAMMING MODE, and when INTERFACE component 303 receive the command from host PC 208, it will transfer the following commands to the flash memory controller 3024.
2. The Second step (step S503) is to identify the type of serial flash. There are plenty of serial flashes and the command sets of these types are not always the same. For the sake of getting the correct command set, the identify step is necessary. The present invention will merge the first two steps together as the Start Flash in FIG. 7.
3. The third step (step S505) is setting WRITE ENABLE. When we are trying to operate an Erase or Write command to a serial flash, there should be a Write Enable command before them or these command will become invalid. The third step is essential step for the next Erase command.
4. The fourth step (step S507), after the Write Enable, the software uses a READ STATUS REGISTER command to check if the command were actually being issued. This step may comprise not more than one Read Status Register command to form the Compare Flash Status step. The third and the fourth step form a complete serial flash Write Enable in FIG. 7.
5. The fifth step (step S509) is an Erase command. Serial flash like most non-volatile memory it can only write the data bit from 1 to 0 and if we want to change the data bit from 0 to 1, that must need an Erase command, first. In this flow, we are trying to write the firmware into the serial flash, so the Erase command cannot be omitted.
6. The sixth step (step S511) is the compare flash status, when the Erase command is finished the busy status will be cleared by the serial flash and that means the Erase command is finished. Just similar to the Write Enable command, the fifth and sixth steps form a complete serial flash Erase in FIG. 7.
7. The seventh step (step of S513) is preparing the write in firmware data. However there will be no interactive between the host and device.
8. After determining whether there are more data to be written in step S515, the eighth step (step of S517) is the Page Write command if more data to be written. A page is 256 bytes for serial flash of the preferred embodiment, and a Page Write command can write 256 bytes to the serial flash. The software is not only need to issue the command bytes but also need to prepare the 256 bytes of firmware.
9. The ninth step (step S519) is the compare flash status. Similar to the Erase command, only when the busy status of the serial flash is cleared, that means the Page Write command is finished. The eighth and the ninth steps can build a complete Page Write in FIG. 7.
10. If there is no more firmware data that should be write into the flash, the last step is to ask the INTERFACE returning to the Normal Mode path (step S521).

The above-mentioned sub-flows, such as START FLASH, WRITE ENABLE, ERASE and PAGE WRITE, can be executed at one period of time in an preferred embodiment, for example, all the Start Flash sub-flows of multi-peripheral devices can be executed at one period of time. More, other sub-flows like all the Write Enable sub-flows, Erase sub-flows, Page Write sub-flows, and End Flash sub-flows of multi-peripheral devices can be executed at one period of time.

In detail, the command sets of those mentioned types have (1) an identify command, and the identify command can be used to detect the type of the non-volatile memory; and (2) a read status command, and the read status command can be used to query the internal status of the non-volatile memory; and (3) a write status command, which can be used to change the internal status of the non-volatile memory; (4) a write enable command, which can be used to enable the write function of the non-volatile memory; (5) an erase command, which can be used to erase the data stored in the non-volatile memory; (6) a write command, which can be used to write data into the non-volatile memory; and (7) a read command, which can be used to read the stored data of the non-volatile memory.

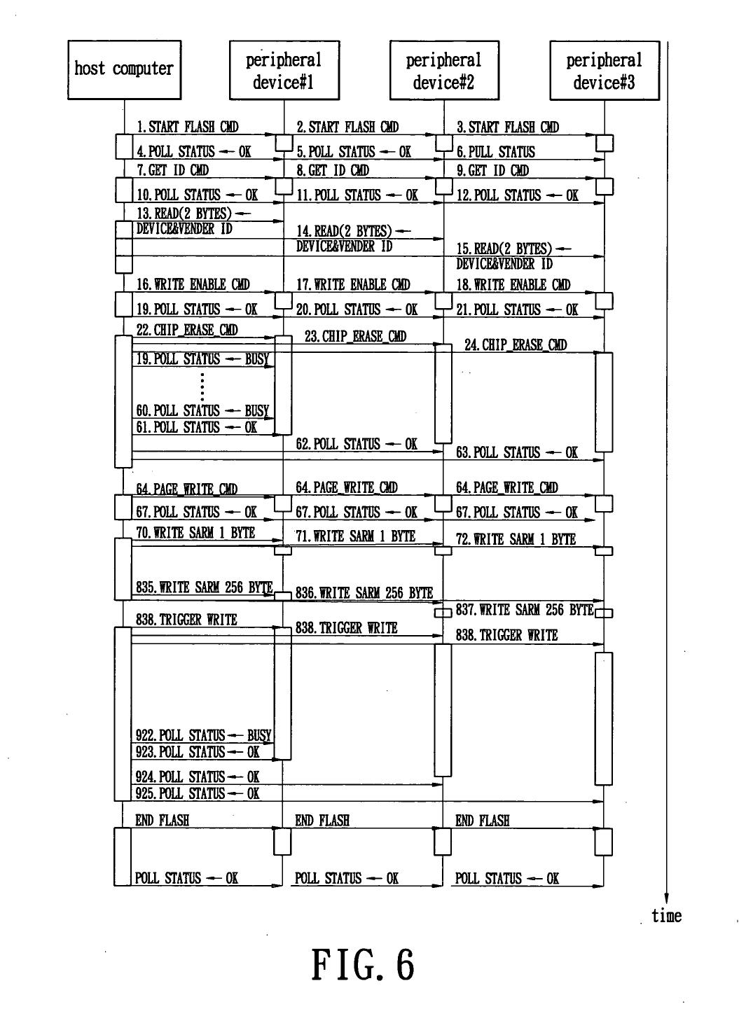

In order to further clarify the operation of the present invention, reference is made to FIG. 6, which shows the detailed operation of the flash memory updating method in accordance with the present invention. As shown in FIG. 6, three peripheral devices, each of which has a flash memory, are updated in this embodiment and designated as peripheral devices #1˜3 respectively. First, in order to switch these three peripheral devices to the flash memory programming mode, the parallel updating program drives the host computer to send out a START_FLASH_CMD command to the peripheral devices 302 which will inform the drive to start the flash updating scenario. When the peripheral devices are switched to the flash memory programming mode, they will update their status to OK status. The host computer can check whether the peripheral devices are switched into the flash memory programming mode by reading the contents of the status of the peripheral devices. Therein, the OK shown in FIG. 6 means that the command of the host computer has been performed and BUSY means the command has not been performed.

When the peripheral devices #1˜3 are switched to the flash memory programming mode, in order to identify the flash memories of these peripheral devices, the parallel memory updating program drives the host computer to send a GET_ID_CMD command to the peripheral devices to obtain the identification codes of the flash memories of the peripheral devices. After receiving the GET_ID_CMD command, each of the peripheral devices reads its flash memory s identification code and stores the identification code into its internal buffer. After the identification code is stored in the internal buffer, each of the flash memory controllers of the peripheral devices update its status to OK informing the host computer that the identification code has been accessed.

In general, the identification code of the flash memory has two bytes of data. The first byte data records a DEVICE ID and the second records a VENDER ID.

After confirming that all of the identification codes of the flash memories of the peripheral devices have been accessed completely, the parallel memory updating program drives the host computer to send a READ command to the peripheral devices to read the identification codes of the flash memories of the peripheral devices. After the READ command is received, each of the flash memory controllers of the peripheral devices transfers the identification code stored in the internal buffer to the host computer.

After the action of reading the identification codes is completed, the parallel memory updating program drives the host computer to send a WRITE_ENABLE command to the peripheral devices to enable the writing function of the flash read-only memory. After receiving the WRITE_ENABLE command, each of the flash memory controllers of the peripheral devices enables the writing function of the flash memory and sets its status to OK to inform the host computer that the WRITE_ENABLE command has been performed.

After the writing function of the flash memories of the peripheral devices is enabled, the parallel memory updating program drives the host computer to send a CHIP_ERASE_CMD command to the peripheral devices to erase the old firmware data stored in the flash read-only memories. After receiving the CHIP_ERASE_CMD command, each of the flash memory controllers of the peripheral devices erases the old firmware data stored in the flash memory and setsits status OK to inform the host computer that the CHIP_ERASE_CMD command has been performed.

As shown in FIG. 6, the action for erasing the old firmware data stored in the flash memories consumes a longer period of time than most of the other actions. Using the conventional method to update the flash memories makes the time consumed when erasing the old firmware data linearly increase proportionally to the number of peripheral devices. However, since the present invention uses a pipeline concept to execute the data erasing action of the flash memories, the present invention makes the peripheral devices erase the old firmware data almost at the same time. Thus, the present invention greatly reduces the time consumed updating the firmware data of the flash memories.

When the data erasing action is completed, the parallel memory updating program drives the host computer to update the flash memories. In this step, the parallel flash memory updating program drives the host computer to send a PAGE_WRITE_CMD command to the peripheral devices. After receiving the PAGE_WRITE_CMD command, each of the flash memory controllers of the peripheral devices gives a write-enable instruction to enable the writing function of the flash memory. After the writing function of the flash memories is enabled, each of the peripheral devices sets its status OK to inform the host computer that the writing function of the flash memories has been enabled.

After that, the parallel memory updating program drives the host computer to transmit the new firmware codes and the related data to the flash memory controllers of the peripheral devices one by one. After receiving the new firmware codes and the related data, each of the peripheral devices writes the new firmware codes and the related data into its internal buffer. After writing a portion of the new firmware data, for example, 256 bytes data, into the internal buffer of the peripheral devices, the parallel memory updating program drives the host computer to send a TRIGGER_WRITE command to the peripheral devices. After receiving the TRIGGER_WRITE command, each of the flash memory controllers of the peripheral devices reads the new firmware data stored in the internal buffer and then firmware data into the flash memory. After the new firmware data written into the flash memories, each peripheral device sets its status OK to inform the host computer that the new firmware data stored in the internal buffers has been written into the flash read-only memories.

After writing the new firmware data stored in the internal buffers into the flash memories, the parallel memory updating program drives the host computer to check whether the new firmware data has been completely written into the flash memories of the peripheral devices. If no, the parallel memory updating program drives the host computer to repeat the same actions mentioned above. This means that the PAGE_WRITE_CMD command will be sent out again to store the next portion of the new firmware data into the internal buffers of the peripheral devices; next, the TRIGGER_WRITE command is also sent out again to drive the flash memory controllers to write the new firmware data stored in the internal buffers into the flash read-only memories. The parallel memory updating program drives the host computer to repeat the same actions mentioned above until the new firmware data is completely written into the flash read-only memories.

It should be noted that the action of writing the new firmware data, which is originally stored in the internal buffer, into the flash read-only memories takes quite a long time. Using the conventional method to update the flash memories makes the time consumed when writing the new firmware data into the flash memories linearly increase proportionally to the number of peripheral devices. However, since the present invention uses a pipeline concept to execute the writing action of the flash memories, the present invention makes the peripheral devices write the new firmware data into the flash memories almost at the same time. Thus, the present invention greatly reduces the time consumed when updating the firmware data of flash memories.

When the new firmware data is completely written into the flash memories of the peripheral devices, the parallel memory updating program drives the host computer to send out an END_FLSH command to end the updating process of the flash memories. After receiving this command, each of the flash memory controllers of the peripheral devices is switched from the flash memory updating mode to the normal operation mode and each of the peripheral devices is reactivated. Thus, every peripheral device is driven to perform its functions according to the new firmware codes.

It should be noted that the present invention could be applied for more peripheral devices even though the embodiment mentioned above only has three peripheral devices. Basically, the present invention can be applied for updating the flash memories of multiple peripheral devices. This means that the present invention can be used for updating the flash memories of two or more flash memories of peripheral devices. Furthermore, when in the normal operation mode, the interface can operate according to, for example, the serial advanced technology attachment (SATA) standard or the parallel advanced technology attachment (PATA) standard, USB, Ethernet or wireless protocol.

Reference is made to FIG. 7, which is a time diagram of the operative steps of the method for updating flash memories of peripheral devices in a parallel matter in accordance with the present invention. As show in FIG. 7, since the present invention uses a pipeline concept to update flash memories of peripheral devices, the present invention is capable of erasing or writing the flash memories at the same time. Hence, the present invention greatly reduces the time consumed when updating the firmware data of the flash memories.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

What is claimed is:

1. A parallel memory updating method, applied for a host computer, the host computer being capable of updating non-volatile memories of multiple peripheral devices via an interface at the same time, the method comprising:
(a) separating one non-volatile memory updating flow into one or more sub-flows for different peripheral devices of the host computer, wherein each sub-flow has a specific period of execution time; and
(b) executing the sub-flows individually.

2. The method as claimed in claim 1, wherein the sub-flows are executed at the same time.

3. The method as claimed in claim 1, further comprising:
merging several non-volatile memory updating steps into a non-volatile memory updating sub-flow and all updating steps can be merged into several updating sub-lows; and
executing each sub-flow by a parallel memory updating program with one or more sub-flows of other peripheral devices at the same time.

4. The method as claimed in claim 1, the updating method further comprising:
(a) asking the peripheral device to invoke the command set of the non-volatile memory by a parallel memory updating program;
(b) preparing write-in data using the parallel memory updating program;
(c) performing write-in and read-out data using the parallel memory updating program; and
(d) initializing and finalizing the parallel memory updating program.

5. The method as claimed in claim 1, further comprising:
(a) informing the peripheral device preparing to updating the non-volatile memory and identifying the type of the non-volatile memory;
(b) enabling the write function of a non-volatile memory and conforming the write function has been correctly be invoked;
(c) erasing the non-volatile memory and conforming the erase has been correctly be invoked;
(d) writing a page data into the non-volatile memory and conforming the write-in action has been correctly be done; and
(e) the peripheral devices returning a normal mode and operate their designed function after finishing accessing the non-volatile memory.

6. The method as claimed in claim 4, wherein the step of writing further comprises a step of asking the peripheral devices to invoke the command sets of the non-volatile memories, wherein the parallel memory updating program uses a pre-defined ATA/ATAPI command, a pre-defined serial, or a pre-defined parallel electronic signals.

7. The method as claimed in claim 4, wherein the command sets have:
(a) an identify command, which can be used to detect the type of the non-volatile memory;
(b) a read status command, which can be used to query the internal status of the non-volatile memory;
(c) a write status command, which can be used to change the internal status of the non-volatile memory;
(d) a write enable command, which can be used to enable the write function of the non-volatile memory;
(e) an erase command, which can be used to erase the data stored in the non-volatile memory;
(f) a write command, which can be used to write data into the non-volatile memory; and
(g) a read command, which can be used to read the stored data of the non-volatile memory.

8. The method as claimed in claim 5, further comprising:
(a) executing all the Start Flash sub-flows of multi-peripheral devices at one period of time;
(b) executing all the Write Enable sub-flows of multi-peripheral devices at one period of time;
(c) executing all the Erase sub-flows of multi-peripheral devices at one period of time;
(d) executing all the Page Write sub-flows of multi-peripheral devices at one period of time; and
(e) executing all the End Flash sub-flows of multi-peripheral devices at one period of time to decrease the average non-volatile memory updating time.

9. A parallel flash memory updating system, comprising:
(a) an interface electrically connected to a host computer and multiple peripheral devices, wherein the host computer having a parallel memory updating program and each of the peripheral devices having a non-volatile memory; and
(b) a non-volatile memory controller, wherein the parallel memory updating program uses the interface to drive the non-volatile memory controller and a pipeline architecture to update the non-volatile memories of the peripheral devices.

10. The system as claimed in claim 9, wherein each of the peripheral devices has an internal buffer to temporarily store data sent from the host computer to the peripheral devices, and the data was prepared to write into the non-volatile memory the internal buffer can store the data that was read out from the non-volatile memory and prepared to read to the host by the parallel memory updating program.
